(19) United States
(12) Patent Application Publication
(10) Pub. No.: US 2023/0395832 A1
(43) Pub. Date: Dec. 7, 2023

(54) FUEL CELL POWER GENERATION SYSTEM AND CONTROL METHOD OF FUEL CELL POWER GENERATION SYSTEM

(71) Applicant: MITSUBISHI HEAVY INDUSTRIES, LTD., Tokyo (JP)

(72) Inventors: Mitsuyoshi Iwata, Yokohama-shi (JP); Takahiro Machida, Yokohama-shi (JP); Nagao Hisatome, Yokohama-shi (JP)

(73) Assignee: MITSUBISHI HEAVY INDUSTRIES, LTD., Tokyo (JP)

(21) Appl. No.: 18/032,911

(22) PCT Filed: Oct. 26, 2021
(86) PCT No.: PCT/JP2021/039388

§ 371 Date: Apr. 20, 2023

(30) Foreign Application Priority Data
Oct. 30, 2020 (JP) 2020-183223

(51) Int. Cl. H01M 8/04746; H01M 8/04119; H01M 8/04007; H01M 8/04537; H01M 8/0438; H01M 8/0444; H01M 8/04492

(52) U.S. Cl. CPC H01M 8/04761; H01M 8/04164; H01M 8/04067; H01M 2008/1293; H01M 8/0438; H01M 8/0444; H01M 8/04492; H01M 8/04574

(57) ABSTRACT

A fuel cell power generation system includes: a first fuel cell; and a second fuel cell connected to a downstream side of the first fuel cell via an exhaust fuel gas line, the second fuel cell being capable of generating electric power using an exhaust fuel gas from the first fuel cell. A water recovery unit is disposed on the exhaust fuel gas line, the water recovery unit being capable of recovering water contained in the exhaust fuel gas. A bypass line brings an upstream side and a downstream side of the exhaust fuel gas line with respect to the water recovery unit into communication. At least one flow control valve is disposed on at least one of the exhaust fuel gas line or the bypass line. A control unit controls an opening degree of the at least one flow control valve.

### TECHNICAL FIELD

The present disclosure relates to a fuel cell power generation system and a control method of the fuel cell power generation system.

The present application claims priority based on Japanese Patent Application No. 2020-183223 filed on Oct. 30, 2020, with the Japanese Patent Office, the contents of which are incorporated herein by reference.

### BACKGROUND ART

A fuel cell which generates electric power through chemical reaction of a fuel gas and an oxidizing gas has excellent characteristics in terms of power generation efficiency and environmentally friendliness, for instance. In particular, a solid oxide fuel cell (SOFC) uses ceramic such as zirconia ceramic as an electrolyte, and supplies, as a fuel gas, a gas such as hydrogen, city gas, natural gas, petroleum, methanol, and a gasified gas produced from a carbon-containing material in a gasification facility, thereby generating electric power in a high-temperature atmosphere of approximately 700° C. to 1000° C.

As an example of a power generation system utilizing such a fuel cell, Patent Document 1 discloses a fuel power generation system including a first fuel cell capable of generating electric power using the first fuel gas, and a second fuel cell capable of generating electric power using exhaust fuel gas from the first fuel cell. In such a fuel cell power generation system connected to a plurality of stages (cascade) of a plurality of fuel cells, the utilization rate of the fuel gas improves, and an excellent efficiency is expected from the system as a whole. Furthermore, in Patent Document 1, the exhaust fuel gas from the first fuel cell of the precedent stage contains water generated from power generation reaction in addition to the fuel not used by the first fuel cell. Water may cause reduction in the heat generation amount of the exhaust fuel gas supplied to the second fuel cell of the subsequent stage, and thus recovered by a water recovery unit disposed between the first fuel cell and the second fuel cell.

### Citation List

### Patent Literature

Patent Document 1: JP3924243B

### SUMMARY

### Problems to be Solved

In a case where a hydrocarbon gas such as city gas is used as a fuel gas for the fuel cell, it is necessary to produce hydrogen (H₂) used in power generation reaction of the fuel cell through reforming reaction. For instance, if a hydrocarbon gas containing methane (CH₄) is used as a fuel gas, the reforming reaction is expressed by the following expression.

CH₄+2H₂O→4H₂+CO₂

In Patent Document 1, the entire amount of the exhaust fuel gas from the first fuel cell of the precedent stage passes through the water recovery unit, and the water recovery amount by the water recovery unit is not controlled. Thus, the water contained in the exhaust fuel gas from the first fuel cell of the precedent stage is recovered by the water recovery unit. Therefore, in Patent Document 1, for the second fuel gas after water is recovered by the water recovery unit, a fuel gas containing water required for reforming reaction at the second fuel cell of the subsequent stage is additionally supplied from the outside. Supplying water again additionally after recovery by the water recovery unit brings about extra energy consumption, which leads to deterioration of the system efficiency.

At least one embodiment of the present disclosure was made in view of the above, and an object is to provide a fuel cell power generation system capable of achieving an excellent system efficiency by supplying water efficiently to the fuel cell of the subsequent stage from among a plurality of fuel cells connected to the flow passages of fuel gas in cascade, and a method of controlling the fuel cell power generation system.

### Solution to the Problems

According to an aspect, to solve the above problem, a fuel cell power generation system includes: a first fuel cell capable of generating electric power using a fuel gas; a second fuel cell connected to a downstream side of the first fuel cell via an exhaust fuel gas line, the second fuel cell being capable of generating electric power using an exhaust fuel gas from the first fuel cell; a water recovery unit disposed on the exhaust fuel gas line, the water recovery unit being capable of recovering water contained in the exhaust fuel gas; a bypass line which brings an upstream side and a downstream side of the exhaust fuel gas line with respect to the water recovery unit into communication; at least one flow control valve disposed on at least one of the exhaust fuel gas line or the bypass line; and a control unit capable of controlling an opening degree of the at least one flow control valve.

According to an aspect, to solve the above problem, a method of controlling a fuel cell power generation system includes: a first fuel cell capable of generating electric power using a fuel gas; a second fuel cell connected to a downstream side of the first fuel cell via an exhaust fuel gas line, the second fuel cell being capable of generating electric power using an exhaust fuel gas from the first fuel cell; a water recovery unit disposed on the exhaust fuel gas line, the water recovery unit being capable of recovering water contained in the exhaust fuel gas; a bypass line which brings an upstream side and a downstream side of the exhaust fuel gas line with respect to the water recovery unit into communication; and at least one flow control valve disposed on at least one of the exhaust fuel gas line or the bypass line. The method includes controlling an opening degree of the at least one flow control valve such that a water contained amount in the exhaust fuel gas becomes equal to a water necessary amount of the second fuel cell.

### Advantageous Effects

According to at least one embodiment of the present disclosure, it is possible to provide a fuel cell power generation system capable of achieving an excellent system efficiency by supplying water efficiently to the fuel cell of the subsequent stage from among a plurality of fuel cells connected to the fuel gas flow passage in cascade, and a method of controlling the fuel cell power generation system.

### BRIEF DESCRIPTION OF DRAWINGS

FIG. 1 is a schematic diagram of an SOFC module according to an embodiment.

FIG. 2 is a schematic cross-sectional view of an SOFC cartridge constituting an SOFC module according to an embodiment.

FIG. 3 is a schematic cross-sectional view of a cell stack constituting an SOFC module according to an embodiment.

FIG. 4 is a schematic configuration diagram of a fuel cell power generation system according to an embodiment.

FIG. 5 is a flowchart of a method of controlling the fuel cell system depicted in FIG. 4.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

Hereinafter, for the sake of convenience of explanation, the positional relationship of each constituent element described using expressions “top” and “bottom” with reference to the page refers to the vertically upper side and the vertically lower side, respectively. Furthermore, in the present embodiment, if the same effect can be achieved in the top-bottom direction and the horizontal direction, the top-bottom direction on the page is not necessarily limited to the vertically top-bottom direction, and may correspond to the horizontal direction orthogonal to the vertical direction.

In the following description, described is an embodiment which uses a solid oxide fuel cell (SOFC) as a fuel cell which constitutes a fuel cell power generation system. In some embodiments, as a fuel cell which constitutes a fuel cell power generation system, a fuel cell of a type other than SOFC (e.g., molten-carbonate fuel cells; MCFC) may be used.

(Configuration of fuel cell module)

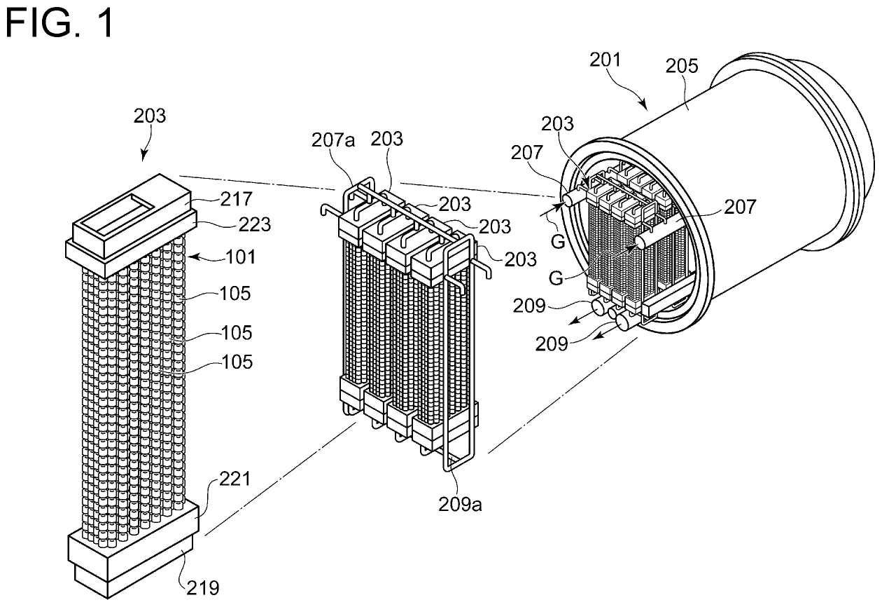

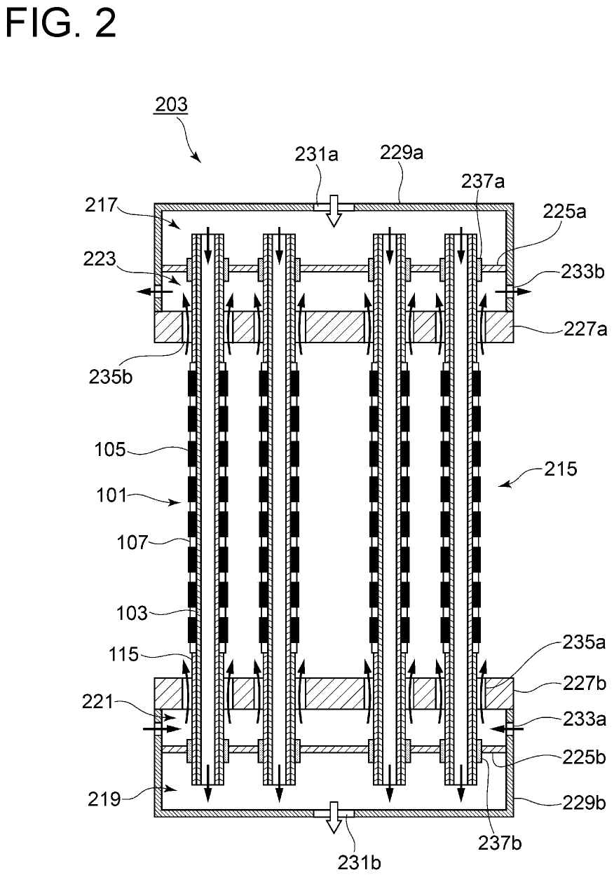

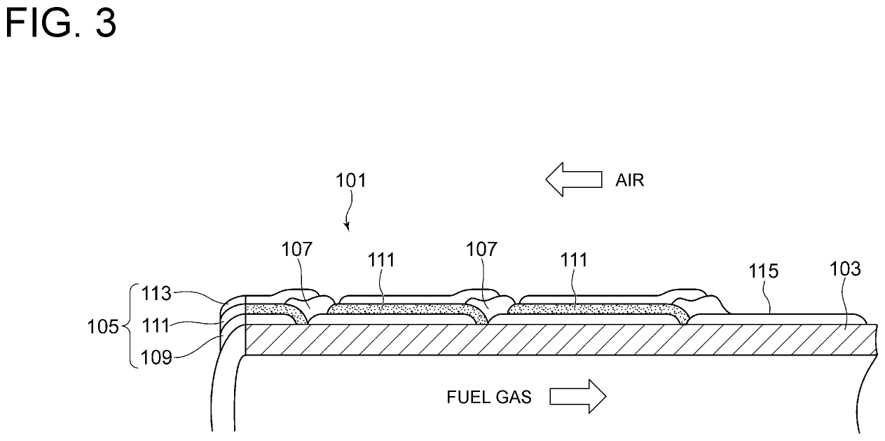

Firstly, with reference to FIGS. 1 to 3, the fuel cell module constituting a fuel cell power generation system according to some embodiments will be described. FIG. 1 is a schematic diagram of an SOFC module (fuel cell module) according to an embodiment. FIG. 2 is a schematic cross-sectional view of an SOFC cartridge (fuel cell cartridge) constituting an SOFC module (fuel cell module) according to an embodiment. FIG. 3 is a schematic cross-sectional view of a cell stack constituting an SOFC module (fuel cell module) according to an embodiment.

The SOFC module (fuel cell module) 201 includes, as depicted in FIG. 1, for instance, a plurality of SOFC cartridges (fuel cell cartridges) 203 and a pressure vessel 205 which accommodates the plurality of SOFC cartridges 203. While the cell stack 101 of the SOC illustrated in FIG. 1 has a cylindrical shape, the drawing is not limitative, and the cell stack may have a flat plate shape. Furthermore, the fuel cell module 201 includes a fuel gas supply pipe 207, a plurality of fuel gas supply branch pipes 207a, a fuel gas exhaust pipe 209 and a plurality of fuel gas exhaust branch pipes 209a. Furthermore, the fuel cell module 201 includes an oxidizing gas supply pipe (not depicted), an oxidizing gas supply branch pipe (not depicted), an oxidizing gas exhaust pipe (not depicted), and a plurality of oxidizing gas exhaust branch pipes (not depicted).

The fuel gas supply pipe 207 is disposed outside the pressure vessel 205, and is connected to a fuel gas supply part (not depicted) for suppling a fuel gas having a predetermined gas composition and a predetermined flow rate in accordance with the power generation amount of the fuel cell module 201 and to the plurality of fuel gas supply branch pipes 207a. The fuel gas supply pipe 207 branches and guides the fuel gas of a predetermined flow rate supplied from the above-described fuel gas supply part to the plurality of fuel gas supply branch pipes 207a. Furthermore, the fuel gas supply branch pipes 207a are connected to the fuel gas supply pipe 207, and to the plurality of SOFC cartridges 203. The fuel gas supply branch pipes 207a guide the fuel gas supplied from the fuel gas supply pipe 207 to the plurality of SOFC cartridges 203 in substantially equal flow rates, to substantially equalize the power generation performance of the plurality of SOFC cartridges 203.

The fuel gas exhaust branch pipes 209a are connected to the plurality of SOFC cartridges 203, and connected to the fuel gas exhaust pipe 209. The fuel gas exhaust branch pipes 209a guide exhaust fuel gas discharged from the SOFC cartridges 203 to the fuel gas exhaust pipe 209. Furthermore, the fuel gas exhaust pipe 209 is connected to the plurality of fuel gas exhaust branch pipes 209a, and partially disposed outside the pressure vessel 205. The fuel gas exhaust pipe 209 guides the exhaust fuel gas guided out from the fuel gas exhaust branch pipes 209a in substantially equal flow rates to the outside of the pressure vessel 205.

The pressure vessel 205 is operated under the internal pressure of 0.1 MPa to approximately 3 Mpa, and the internal temperature of the atmospheric temperature to approximately 550° C., and thus is formed of a material having a durability and an anti-erosion property against an oxidant such as oxygen contained in the oxidizing gas. For instance, a stainless steel material such as SUS 304 is suitable.

Herein, the present embodiment describes an aspect in which the plurality of SOFC cartridges 203 are collectively accommodated in the pressure vessel 205. Nevertheless, the present embodiment is not limited to this, and the SOFC cartridges 203 may be accommodated in the pressure vessel 205 not collectively.

As depicted in FIG. 2, the SOFC cartridge 203 includes a plurality of cell stacks 101, a power generation chamber 215, a fuel gas supply header 217, a fuel gas exhaust header 219, an oxidizing gas (air) supply header 221, and an oxidant gas exhaust header 223. Furthermore, the SOFC cartridge 203 includes an upper tube plate 225a, a lower tube plate 225b, an upper heat insulating body 227a, and a lower heat insulating body 227b.

In the present embodiment, the fuel gas supply header 217, the fuel gas exhaust header 219, the oxidant gas supply header 221, and the oxidant gas exhaust header 223 are arranged as in FIG. 2, and thereby the SOFC cartridge 203 has a structure where the fuel gas and the oxidizing gas flow inside and outside the cell stack 101 in the opposite directions. Nevertheless, the structure is not limitative. For instance, the fuel gas and the oxidizing gas may flow inside and outside the cell stack 101 in the same direction, or the oxidizing gas may flow in a direction orthogonal to the longitudinal direction of the cell stack 101.

The power generation chamber 215 is a region formed between the upper heat insulating body 227a and the lower heat insulating body 227b. The power generation chamber 215 is a region where the single fuel cells 105 of the cell stack 101 are disposed, and is a region which generates electric power through electrochemical reaction of the fuel gas and the oxidizing gas. Furthermore, the temperature in the vicinity of the middle portion of the power generation chamber 215 with respect to the longitudinal direction of the cell stack 101 is monitored with a temperature measurement part (e.g., temperature sensor like a thermocouple), and has a high-temperature atmosphere of approximately 700° C. to 1000° C. during steady operation of the fuel cell module 201.

The fuel gas supply header 217 is a region surrounded by the upper casing 229a and the upper tube plate 225a of the SOFC cartridge 203, and is in communication with the fuel gas supply branch pipe 207a through a fuel gas supply hole 231a disposed on the upper section of the upper casing 229a. Furthermore, the plurality of cell stacks 101 are joined to the upper tube plate 225a via a seal member 237a. The fuel gas supply header 217 guides the fuel gas supplied from the fuel gas supply branch pipe 207a via the fuel gas supply hole 231a to the interior of the substrate tube 103 of the plurality of cell stacks 101 at substantially equal flow rates, and substantially equalizes the power generation performance of the plurality of cell stacks 101.

The fuel gas exhaust header 219 is a region surrounded by the lower casing 229b and the lower tube plate 225b of the SOFC cartridge 203, and is in communication with the fuel gas exhaust branch pipe 209a (not depicted) through a fuel gas exhaust hole 231b disposed on the lower casing 229b. Furthermore, the plurality of cell stacks 101 are joined to the lower tube plate 225b via the seal member 237b. The fuel gas exhaust header 219 collects and guides the exhaust fuel gas supplied to the fuel gas exhaust header 219 through the interior of the substrate tube 103 of the plurality of cell stacks 101 to the fuel gas exhaust branch pipe 209a via the fuel gas exhaust hole 231b.

The oxidizing gas having a predetermined gas composition and a predetermined flow rate is branched to the oxidizing gas supply branch pipes in accordance with the power generation amount of the fuel cell module 201, and supplied to the plurality of SOFC cartridges 203. The oxidant gas supply header 221 is a region surrounded by the lower casing 229b and the lower heat insulating body (support body) 227b of the SOFC cartridge 203, and is in communication with the oxidizing gas supply branch pipe (not depicted) through an oxidizing gas supply hole 233a disposed on the side surface of the lower casing 229a. The oxidant gas supply header 221 guides the oxidizing gas of a predetermined flow rate supplied from the oxidizing gas supply branch pipe (not depicted) via the oxidizing gas supply hole 233a to the power generation chamber 215 via an oxidizing gas supply gap 235a described below.

The oxidant gas exhaust header 223 is a region surrounded by the upper casing 229a and the upper heat insulating body (support body) 227a of the SOFC cartridge 203, and is in communication with the oxidizing gas exhaust branch pipe (not depicted) through an oxidizing gas exhaust hole 233b disposed on the side surface of the upper casing 229a. The oxidant gas exhaust header 223 guides the exhaust oxidizing gas supplied from the power generation chamber 215 via an oxidizing gas exhaust gap 235b described below to the oxidizing gas exhaust branch pipe (not depicted) via the oxidizing gas exhaust hole 233b.

The upper tube plate 225a is fixed to a side plate of the upper casing 229a between the top plate of the upper casing 229a and the upper heat insulating body 227a, such that the upper tube plate 225a, the top plate of the upper casing 229a, and the upper heat insulating body 227a are substantially parallel. Furthermore, the upper tube plate 225a has a plurality of holes corresponding to the number of cell stacks 101 provided for the SOFC cartridge 203, and the cell stacks 101 are inserted into the respective holes. The upper tube plate 225a seals an end portion of each of the plurality of cell stacks 101 air tightly via one or both of the seal member 237a and a bonding member, and separates the fuel gas supply header 217 from the oxidant gas exhaust header 223.

The upper heat insulating body 227a is fixed to a side plate of the upper casing 229a at the lower end portion of the upper casing 229a, such that the upper heat insulating body 227a, the top plate of the upper casing 229a, and the upper tube plate 225a are substantially parallel. Furthermore, the upper heat insulating body 227a has a plurality of holes corresponding to the number of cell stacks 101 provided for the SOFC cartridge 203. The holes have a larger diameter than the outer diameter of the cell stacks 101. The upper heat insulating body 227a includes the oxidizing gas exhaust gap 235b formed between the inner surface of the holes and the outer surface of the cell stacks 101 inserted into the upper heat insulating body 227a.

The upper heat insulating body 227a partitions the power generation chamber 215 and the oxidant gas exhaust header 223, and suppresses a decrease in the strength due to temperature increase of the atmosphere around the upper tube plate 225a, or development of corrosion due to the oxidant in the oxidizing gas. The upper tube plate 225a or the like is formed of a heat-resistant metal material such as Inconel, which prevents thermal deformation when the upper tube plate 225a or the like is exposed to a high temperature inside the power generation chamber 215 and the temperature difference inside the upper tube plate 225a or the like increases. Furthermore, the upper heat insulating body 227a lets the exhaust oxidizing gas exposed to a high temperature after passing through the power generation chamber 215 pass through the oxidizing gas exhaust gap 235b and guides the same to the oxidant gas exhaust header 223.

According to the present embodiment, with the structure of the above described SOFC cartridge 203, the fuel gas and the oxidizing gas flow inside and outside the cell stacks 101 in opposite directions. Accordingly, the exhaust oxidizing gas exchanges heat with the fuel gas supplied to the power generation chamber 215 through the interior of the substrate tube 103, cooled to the temperature at which the upper tube plate 225a or the like formed of a metal material does not undergo distortion such as buckling distortion, and is supplied to the oxidant gas exhaust header 223. Furthermore, the fuel gas is heated through heat exchange with the exhaust oxidizing gas discharged from the power generation chamber 215, and is supplied to the power generation chamber 215. As a result, it is possible to supply the power generation chamber 215 with the fuel gas pre-heated to a temperature suitable for power generation without using a heater or the like.

The lower tube plate 225b is fixed to a side plate of the lower casing 229b between the bottom plate of the lower casing 229b and the lower heat insulating body 227b, such that the lower tube plate 225b, the bottom plate of the lower casing 229b, and the lower heat insulating body 227b are substantially parallel. Furthermore, the lower tube plate 225b has a plurality of holes corresponding to the number of cell stacks 101 provided for the SOFC cartridge 203, and the cell stacks 101 are inserted into the respective holes. The lower tube plate 225b seals the other end portion of each of the plurality of cell stacks 101 air tightly via one or both of the seal member 237b and a bonding member, and separates the fuel gas exhaust header 219 from the oxidant gas supply header 221.

The lower heat insulating body 227b is fixed to a side plate of the lower casing 229b at the upper end portion of the lower casing 229b, such that the lower heat insulating body 227b, the bottom plate of the lower casing 229b, and the lower tube plate 225b are substantially parallel. Furthermore, the lower heat insulating body 227b has a plurality of holes corresponding to the number of cell stacks 101 provided for the SOFC cartridge 203. The holes have a larger diameter than the outer diameter of the cell stacks 101. The lower heat insulating body 227b has the oxidizing gas supply gap 235a formed between the inner surface of the holes and the outer surface of the cell stacks 101 inserted into the lower heat insulating body 227b.

The lower heat insulating body 227b partitions the power generation chamber 215 and the oxidant gas supply header 221, and suppresses a decrease in the strength due to temperature increase of the atmosphere around the lower tube plate 225b, or development of corrosion due to the oxidant in the oxidizing gas. The lower tube plate 225b or the like is formed of a heat-resistant metal material such as Inconel, which prevents thermal deformation when the lower tube plate 225b or the like is exposed to a high temperature and the temperature difference inside the lower tube plate 225b or the like increases. Furthermore, the lower heat insulating body 227b guides the oxidizing gas supplied to the oxidant gas supply header 221 to the power generation chamber 215 through the oxidizing gas supply gap 235a.

According to the present embodiment, with the structure of the above described SOFC cartridge 203, the fuel gas and the oxidizing gas flow inside and outside the cell stacks 101 in opposite directions. Accordingly, the exhaust fuel gas after passing through the interior of the substrate tube 103 and the power generation chamber 215 exchanges heat with the oxidizing gas supplied to the power generation chamber 215, cooled to a temperature at which the lower tube plate 225b or the like formed of a metal material does not undergo distortion such as buckling distortion, and is supplied to the fuel gas exhaust header 219. Furthermore, the oxidizing gas is heated through heat exchange with the exhaust fuel gas, and is supplied to the power generation chamber 215. As a result, it is possible to supply the power generation chamber 215 with the oxidizing gas heated to a temperature suitable for power generation without using a heater or the like.

The direct-current electric power generated in the power generation chamber 215 is guided to the vicinity of the end portion of the cell stack 101 by the lead film 115 including Ni/YSZ or the like disposed on the plurality of single fuel cells 105, collected to a current collector rod (not depicted) of the SOFC cartridge 203 via a current collector plate (not depicted), and then extracted out of each SOFC cartridge 203. The direct-current electric power guided out of the SOFC cartridge 203 by the current collector rod is, the power of each SOFC cartridge 203 is connected to a predetermined serial number and a predetermined parallel number interactively, guided to the outside of the fuel cell module 201, converted to predetermined alternate-current electric power by an electric power converter (e.g., inverter) such as a power conditioner (not depicted), and is supplied to a power recipient (e.g., load system or electric system).

As depicted in FIG. 3, as an example, the cell stack 101 includes a substrate tube 103 having a cylindrical shape, a plurality of single fuel cells 105 formed on the outer peripheral surface of the substrate tube 103, and an interconnector 107 formed between adjacent single fuel cells 105. The single fuel cell 105 is formed by laminating a fuel-side electrode 109, an electrolyte 111, and an oxygen-side electrode 113. Furthermore, the cell stack 101 includes a lead film 115 electrically connected, via the interconnector 107, to the oxygen-side electrode 113 of the single fuel cell 105 that is formed on one of the farthest ends of the substrate tube 103 in the axial direction, and a lead film 115 electrically connected to the fuel-side electrode 109 of the single fuel cell 105 that is formed on the other one of the farthest ends of the substrate tube 103 in the axial direction, from among the plurality of single fuel cells 105 formed on the outer peripheral surface of the substrate tube 103.

The substrate tube 103 is formed of a porous material, and includes CaO-stabilized ZrO₂(CSZ), a compound of CSZ and oxidized nickel (NiO) (CSZ+NiO), or Y₂O₃-stabilized ZrO₂(YSZ), or MgAl₂O₄ as main components, for instance. The substrate tube 103 supports the single fuel cell 105, the interconnector 107, and the lead film 115, and spreads a fuel gas supplied to the inner peripheral surface of the substrate tube 103 to the fuel-side electrode 109 formed on the outer peripheral surface of the substrate tube 103 via the fine pores of the substrate tube 103.

The fuel-side electrode 109 includes an oxide of a compound of Ni and a zirconia-based electrolyte material, and Ni/YSZ is used, for instance. The thickness of the fuel-side electrode 109 is 50 μm to 250 μm, and the fuel-side electrode 109 may be formed by screen printing slurry. In this case, Ni, a component of the fuel-side electrode 109, has catalysis with the fuel gas. The catalysis causes the fuel gas supplied via the substrate tube 103, which is a gas mixture of methane (CH₄) and vapor for instance to react, and reform the same into hydrogen (H₂) and carbon monoxide (CO). Furthermore, the fuel-side electrode 109 causes hydrogen (H₂) and carbon monoxide (CO) obtained by reformulation and oxygen ion (O²⁻) supplied via the electrolyte 111 to react electrochemically in the vicinity of the interface to the electrolyte 111, thereby producing water (H₂O) and carbon dioxide (CO₂). At this time, the single fuel cell 105 generates electric power with electrons discharged from oxygen ions.

A fuel gas that can be supplied to and used for the fuel-side electrode 109 of a solid-oxide fuel cell includes, for instance, a hydrocarbon gas such as hydrogen (H₂) and carbon monoxide (CO), methane (CH₄), city gas, natural gas, as well as petroleum, methanol, and a gasified gas produced from a carbon containing raw material such as coal in a gasification facility.

As the electrolyte 111, YSZ having an air tightness that hardly lets through a gas and a high oxygen-ion conductivity at a high temperature is mainly used. The electrolyte 111 transfers oxygen ions (O₂₋) produced at the oxygen-side electrode to the fuel-side electrode. The film thickness of the electrolyte 111 positioned on the surface of the fuel-side electrode 109 is 10 μm to 100 μm, and the electrolyte 111 may be formed by screen printing slurry.

The oxygen-side electrode 113 includes, for instance, a LaSrMnO₃-based oxide or a LaCoO₃-based oxide, and the oxygen-side electrode 113 is formed by screen printing slurry or applying slurry using a dispenser. The oxygen-side electrode 113 disassociates oxygen in a supplied oxidizing gas such as air and produces oxygen ions (O²⁻), in the vicinity of the interface to the electrolyte 111.

The oxygen-side electrode 113 may have two layers. In this case, an oxygen-side electrode layer (oxygen-side electrode middle layer) closer to the electrolyte 111 is formed of a material that has a high ion conductivity and an excellent catalyst activity. The oxygen-side electrode layer on the oxygen-side electrode middle layer (oxygen-side electrode conductive layer) may be formed of a perovskite-type oxide expressed as Sr and Ca-doped LaMnO₃. Accordingly, it is possible to improve the power generation performance even more.

An oxidizing gas is a gas which contains approximately 15% to 30% of oxygen, and air is a suitable representative. Nevertheless, besides air, a gas mixture of combustion exhaust gas and air, or a gas mixture of oxygen and air can be used.

The interconnector 107 includes a conductive perovskite-type oxide expressed as M₁₋ₓLxTiO₃ (M is an alkali earth metal element and L is a lanthanoid element) such as an SrTiO₃-based oxide, and is formed by screen printing slurry. The interconnector 107 is formed as a fine film such that the fuel gas and the oxidizing gas do not mix. Furthermore, the interconnector 107 has a high durability and a high electric conductivity under both of an oxidizing atmosphere and a reducing atmosphere. Between adjacent single fuel cells 105, the interconnector 107 electrically connects the oxygen-side electrode 113 of one of the single fuel cells 105 and the fuel-side electrode 109 of the other one of the single fuel cells 105, thereby connecting the adjacent single fuel cells 105 in series.

The lead film 115 needs to have an electron conductivity and a heat expansion coefficient close to other materials constituting the cell stack 101, and thereby consists of a compound material of Ni such as Ni/YSZ and a zirconia-based electrolyte material, or M1-xLxTiO₃ such as an SrTiO₃-based material ((M is an alkali earth metal element and L is a lanthanoid element). The lead film 115 guides the direct-current electric power generated by the plurality of single fuel cells 105 connected in series via the interconnector 107 to the vicinity of an end portion of the cell stack 101.

In some embodiments, instead of providing the fuel-side electrode or the oxygen- side electrode separately from the substrate tube, the fuel-side electrode or the oxygen-side electrode may be formed to be thick to also serve as the substrate tube. Furthermore, while the substrate tube in the present embodiment has a cylindrical shape, it is sufficient if the substrate tube has a tubular shape. The cross-section is not limited to a circular shape, and may be an oval shape, for instance. The cell stack may have a flat tubular shape which is a tube whose circumferential surface is flattened in the perpendicular direction.

(Configuration of fuel cell power generation system)

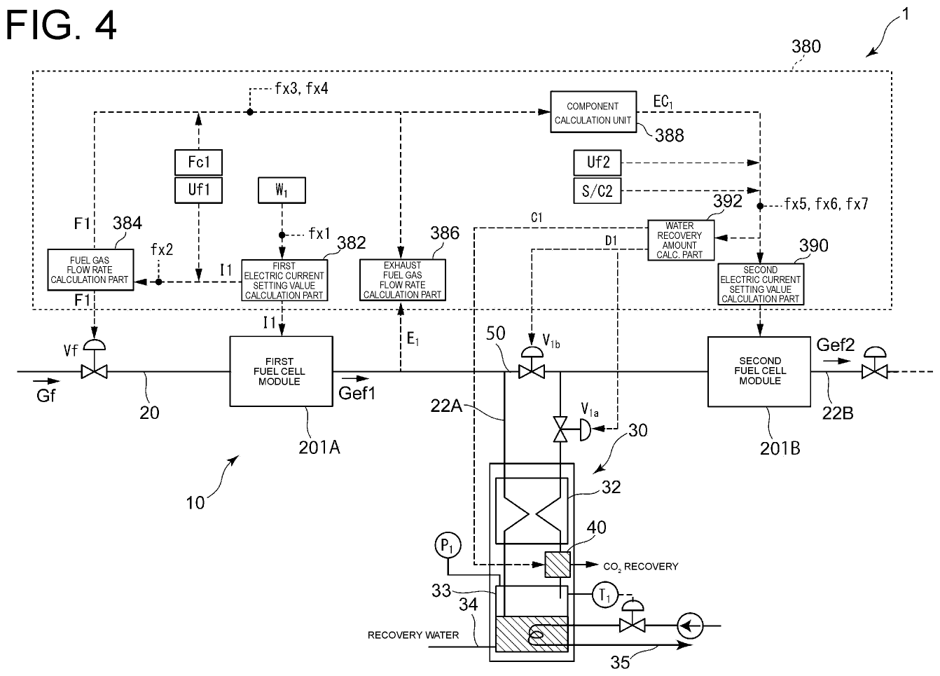

Next, the fuel cell power generation system 1 utilizing the fuel cell module 201 having the above configuration will be described. FIG. 4 is a schematic configuration diagram of a fuel cell power generation system 1 according to an embodiment.

As depicted in FIG. 4, the fuel cell power generation system 1 includes a fuel cell part 10 including the first fuel cell module 201A and the second fuel cell module 201B, a fuel gas supply line 20 for supplying a fuel gas Gf to the fuel cell part 10, the first exhaust fuel gas line 22A through which the first exhaust fuel gas Gef1 discharged from the first fuel cell module 201A flows, and the second exhaust fuel gas line 22B through which the second exhaust fuel gas Gef2 discharged from the second fuel cell module 201B flows. Furthermore, although not depicted in FIG. 4, the fuel cell power generation system 1 includes an oxidizing gas supply line for supplying oxidizing gas (air) to the fuel cell part 10, the first exhaust oxidizing gas line through which the first exhaust oxidizing gas discharged from the first fuel cell module 201A flows, and a second exhaust oxidizing gas line through which the second exhaust oxidizing gas from the second fuel cell module 201B flows.

The first fuel cell module 201A and the second fuel cell module 201B include at least one fuel cell cartridge 203 as described above, and the fuel cell cartridge 203 includes a plurality of cell stacks 101 each of which includes a plurality of single fuel cells 105 (see FIGS. 1 and 2). Each of the single fuel cells 105 includes a fuel-side electrode 109, an electrolyte 111, and an oxygen-side electrode 113 (see FIG. 3).

In FIG. 4, the fuel cell part 10 is configured such that the first fuel cell module 201A and the second fuel cell module 201B are connected in series (cascade) with respect to the fuel gas supply line 20, and thereby the first exhaust fuel gas Gef1 discharged from the first fuel cell module 201A of the precedent stage is supplied to the second fuel cell module 201B of the subsequent stage via the first exhaust fuel gas line 22A. The second exhaust fuel gas Gef2 from the second fuel cell module 201B of the subsequent stage is discharged to the outside via the second exhaust fuel gas line 22B.

In the present embodiment, two fuel cell modules are connected in series (cascade) to the fuel gas supply line 20. The number of the fuel cell modules to be connected in series (cascade) is not limited to two, and may be three or more.

The fuel gas supply line 20 corresponds to the fuel gas supply pipe 207 depicted in FIG. 1, and the first exhaust fuel gas line 22A corresponds to the fuel gas exhaust pipe 209.

On the fuel gas supply line 20, a fuel gas supply amount adjustment valve Vf for adjusting the supply amount of the fuel gas Gf to the fuel cell part 10 is disposed. The opening degree of the fuel gas supply amount adjustment valve Vf is controllable on the basis of a control signal from the control unit 380 described below.

Furthermore, on the first exhaust fuel gas line 22A, a water recovery unit 30 for recovering water (H₂O) contained in the first exhaust fuel gas Gef1 is disposed. The water recovery unit 30 includes a water condenser 33 for condensing and removing extra water contained in exhaust fuel gas by cooling the exhaust fuel gas, and an exhaust fuel gas regeneration heat exchanger 32 for reheating exhaust fuel gas after condensation and removal of water. A cooling water line 35 and a recovery water line 34 are connected to the water condenser 33, and it is possible to discharge the condensed and removed recovery water to the outside as needed.

Furthermore, on the first exhaust fuel gas line 22A, a carbon dioxide recovery unit for recovering carbon dioxide (CO₂) contained in the first exhaust fuel gas Gef1 is disposed. The carbon dioxide recovery unit 40 includes a CO₂ separation membrane, for instance. The CO₂ water recovery amount recovered by the carbon dioxide recovery unit 40 can be utilized as an industrial raw material, a food raw material, or for concrete injection.

The bypass line 50 is disposed so as to bring the upstream side and the downstream side of the first exhaust fuel gas line 22A with respect to the H₂O recovery unit into communication. The exhaust fuel gas Gef1 from the fuel cell module 201A is capable of selecting between a flow passage that passes through the water recovery unit 30 and the carbon dioxide recovery unit 40 along the first exhaust fuel gas line 22A, and a flow passage that passes through the bypass line 50, in accordance with the opening degree of the flow control valve disposed on at least one of the first exhaust fuel gas line 22A or the bypass line 50. Accordingly, it is possible to adjust the ratio of the exhaust fuel gas Gef1 flowing through the two flow passages optionally through the opening degree of the flow control valve.

In the present embodiment, as such a flow control valve, the first flow control valve V1a is disposed on the first exhaust fuel gas line 22A, and the second flow control valve V1b is disposed on the bypass line 50. The opening degrees of the first flow control valve V1a and the second flow control valve V1b are each controllable by the control unit 380 described below. More specifically, the control unit 380 controls the opening degree ratio of the flow control valve V1a and the second flow control valve V1b to adjust the ratio of the first exhaust fuel gas Gefl flowing through the above two flow passages.

The fuel cell power generation system 1 includes a control unit 380 for controlling the respective configurations of the fuel cell power generation system 1. The control unit 380 includes, for instance, a central processing unit (CPU), a random access memory (RAM), a read only memory (ROM), and a storage medium or the like that is readable by a computer. Further, a series of processes for realizing the various functions is stored in the storage medium in the form of program, for instance. As the CPU reads the program out to the RAM or the like and executes processing and calculation of information, various functions are realized. The program may be installed in advance in the ROM or another storage medium, provided in a state stored in a storage medium that is readable by a computer, or may be distributed via wired communication or wireless communication. A storage medium that is readable by a computer refers to a magnetic disc, a magneto-optic disc, a CD-ROM, a DVD-ROM, a semiconductor memory, or the like.

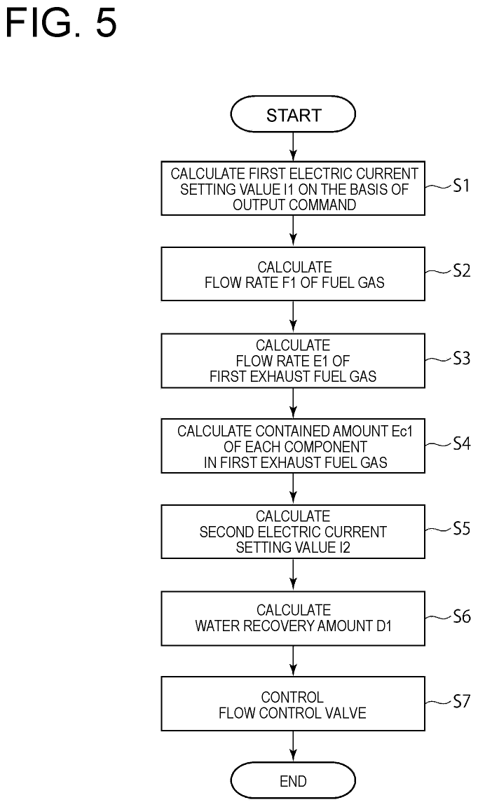

The control unit 380 includes, as in FIG. 4 that shows the internal configuration as functional blocks, a first electric current setting value calculation part 382, a fuel gas flow rate calculation part 384, an exhaust fuel gas flow rate calculation part 386, a component calculation unit 388, a second electric current setting value calculation part 390, and a water recovery amount calculation part 392. Each of the above constituent elements of the control unit 380 operates in accordance with the control method described below. FIG. 5 is a flowchart of a method of controlling the fuel cell power generation system 1 depicted in FIG. 4.

Firstly, of the control unit 380, the first electric current setting value calculation part 382 calculates the first electric current setting value I1 of the first fuel cell module 201A on the basis of the output command W1 obtained from the outside (step Si). The relationship between the output command W1 and the electric current setting value I1 is determined in advance as a function fx1, and in step S1, the electric current setting value I1 of the first fuel cell module 201A is calculated by inputting the output command W1 obtained by the control unit 380 into the function fx1. The electric current setting value I1 calculated in step S1 is outputted as a control parameter to the first fuel cell module 201A, and is used in the following calculation.

Next, the fuel gas flow rate calculation part 384 calculates the flow rate F1 of the fuel gas Gf supplied to the first fuel cell module 201A on the basis of the electric current setting value I1 calculated in step S1 (step S2). In step S2, the fuel gas flow rate calculation part 384 calculates the flow rate F1 of the fuel gas Gf using the fuel utilization rate Uf1 of the first fuel cell module 201A and the fuel composition Fc1 of the fuel gas Gf, which are parameters set in advance, in addition to the electric current setting value I1 calculated in step S1. The relationship between the electric current setting value I1, the fuel utilization rate Uf1 and the fuel composition Fc1, and the flow rate F1 of the fuel gas Gf is determined in advance as a function fx2. In step S2, the electric current setting value I1 calculated in step S1, and the fuel utilization rate Uf1 and the fuel composition Fc1 set in advance are inputted into the function fx2, and the flow rate F1 of the fuel gas Gf is calculated.

Next, the exhaust fuel gas flow rate calculation part 386 calculates the flow rate E1 of the first exhaust fuel gas Gef1 from the first fuel cell module 201A on the basis of the electric current setting value I1 calculated in step S1, the flow rate F1 of the fuel gas Gf calculated in step S2, and the fuel composition Fc1 set in advance (step S3). The relationship between the flow rate F1 of the fuel gas Gf and the fuel composition Fc1, and the flow rate E1 of the first exhaust fuel gas Gef1 is determined in advance as a function fx3. In step S3, the flow rate F1 of the fuel gas Gf calculated in step S2, and the fuel composition Fc1 set in advance are inputted into the function fx3, and thereby the flow rate E1 of the first exhaust fuel gas Gef1 is calculated. The flow rate E1 of the first exhaust fuel gas Gefl calculated accordingly is used in a feedback control related to the flow rate of the exhaust fuel gas Gef.

Next, the component calculation unit 388 calculates the contained amount Ec1 of each component (CH₄/H₂/CO/H₂O/CO₂) contained in the first exhaust fuel gas Gef1 on the basis of the flow rate F1 of the fuel gas Gf calculated in step S2 and the fuel composition Fc1 set in advance (step S4). The relationship between the flow rate F1 of the fuel gas Gf and the fuel composition Fc1, and the contained amount Ec1 of each component of the first exhaust fuel gas Gef1 is determined in advance as a function fx4. In step S4, the flow rate F1 of the fuel gas Gf calculated in step S2, and the fuel composition Fc1 set in advance are inputted into the function fx4, and thereby the contained amount Ec1 of each component of the first exhaust fuel gas Gef1 is calculated.

Next, the second electric current setting value calculation part 390 calculates the electric current setting value 12 of the second fuel cell module 201B on the basis of the contained amount Ec1 of each component of the first exhaust fuel gas Gef1 calculated in step S4, and the fuel utilization rate Uf2 of the second fuel cell module 201B set in advance (step 5). The relationship between the contained amount Ec1 and the fuel utilization ratio Uf2 of the first exhaust fuel gas Gef1 and the electric current setting value 12 is determined in advance as a function fx5. In step S5, the contained amount Ec1 of each component of the first exhaust fuel gas Gef1 calculated in step S4, and the fuel utilization rate Uf2 set in advance are inputted into the function fx5, and thereby the electric current setting value 12 is calculated. The electric current setting value I2 calculated in step S5 is outputted as a control parameter to the second fuel cell module 201B.

Next, the water recovery amount calculation part 392 calculates the water recovery amount D1 by the water recovery unit 30 on the basis of the contained amount Ec1 of each component of the first exhaust fuel gas Gef1 calculated in step S4, and the fuel utilization rate Uf2 of the second fuel cell module 201B set in advance and the optimum S/C value (S/C2) of the second fuel cell module 201B set in advance (step S6). Specifically, the current water contained amount in the first exhaust fuel gas Gef1 is calculated on the basis of the contained amount Ec1 of each component in the first exhaust fuel gas Gef1 calculated in step S4, and the necessary amount of water required for reforming reaction in the second fuel cell module 201B is calculated on the basis of the contained amount Ec1 of the fuel component in the first exhaust fuel gas Gef1 and the fuel utilization ratio Uf2 of the second fuel cell module 201B set in advance and the optimum S/C value (S/C2) of the second fuel cell module 201B. Then, the water amount to be recovered by the water recovery unit 30 is determined from the difference between the current water contained amount and the water necessary amount. In the water recovery amount calculation part 392, the relationship between the contained amount Ec1 of each component of the first exhaust fuel gas Gef1, the fuel utilization rate Uf2 of the second fuel cell module 201B, and the optimum S/C value (S/C2) of the second fuel cell module 201B, and the water recovery amount D1 is determined in advance as a function fx6. In step S6, the contained amount Ec1 of each component of the first exhaust fuel gas Gef1, and the fuel utilization rate Uf2 of the second fuel cell module 201B and the optimum S/C value (S/C2) of the second fuel cell module 201B are inputted into the function fx6, and thereby the water recovery amount D1 of the water recovery unit 30 is calculated.

Next, the control unit 380 controls the opening degree of the at least one flow control valve on the basis of the water recovery amount D1 calculated accordingly (step S7). In the present embodiment, the control unit 380 controls the opening degree ratio of the first flow control valve V1 a and the second flow control valve V1b to change the flow rate of the first exhaust fuel gas Gef1 that passes through the water recovery unit 30, and the water recovery amount by the water recovery unit 30 is controlled to be the water recovery amount D1 calculated in step S6. Accordingly, the first exhaust fuel gas Gef1 supplied to the second fuel cell module 201B of the subsequent stage appropriately contains a necessary amount of water required for reforming reaction in the second fuel cell module 201B. As a result, it is possible to ensure necessary water for the second fuel cell module 201B without additionally supplying water from outside while recovering extra water discharged from the first fuel cell module 201A by the water recovery unit 30, and reheat the exhaust fuel gas after removal of water with the exhaust fuel gas regeneration heat exchanger 32. Therefore, it is possible to realize a fuel cell power generation system 1 having a high system efficiency.

It should be noted that the water recovery amount calculation part 392 may calculate the carbon dioxide water recovery amount C1 by the carbon dioxide recovery unit 40 on the basis of the contained amount Ec1 of each component of the first exhaust fuel gas Gef1 calculated in step S4, and the fuel utilization rate Uf2 of the second fuel cell module 201B set in advance and the optimum S/C value (S/C2) of the second fuel cell module 201B set in advance. In this case, in the water recovery amount calculation part 392, the relationship between the contained amount Ec1 of each component of the first exhaust fuel gas Gef1, the fuel utilization rate Uf2 of the second fuel cell module 201B and the optimum S/C value (S/C2) of the second fuel cell module 201B, and the carbon dioxide water recovery amount C1 is determined in advance as a function fx7. The contained amount Ec1 of each component of the first exhaust fuel gas Gef1, and the fuel utilization rate Uf2 of the second fuel cell module 201B and the optimum S/C value (S/C2) of the second fuel cell module 201B are inputted into the function fx7, and thereby the carbon dioxide water recovery amount C1 of the carbon dioxide recovery unit 40 is calculated.

The carbon dioxide recovery unit 40 recovers carbon dioxide from the first exhaust fuel gas Gef1 on the basis of the carbon dioxide water recovery amount C1 calculated as described above. Accordingly, it is possible to reduce carbon dioxide discharged from the fuel cell power generation system 1, improve the environmental performance, and effectively utilize the recovered carbon dioxide for another usage, thereby improving the system efficiency and the operation costs.

As described above, according to the above embodiment, it is possible to provide a fuel cell power generation system 1 capable of achieving an excellent system efficiency by supplying water efficiently to the fuel cell module 201B of the subsequent stage from among a plurality of fuel cells connected in cascade to the flow passage of fuel gas Gf.

The contents described in the above respective embodiments can be understood as follows, for instance.

(1) According to an aspect, a fuel cell power generation system (e.g., the fuel cell power generation system 1 of the above embodiment) includes: a first fuel cell (e.g., the first fuel cell module 201A of the above embodiment) capable of generating electric power using a fuel gas (e.g., the fuel gas Gf of the above embodiment); a second fuel cell (e.g., the second fuel cell module 201B of the above embodiment) connected to a downstream side of the first fuel cell via an exhaust fuel gas line (e.g., the first exhaust fuel gas line 22A of the above embodiment), the second fuel cell being capable of generating electric power using an exhaust fuel gas (the first exhaust fuel gas Gef1 of the above embodiment) from the first fuel cell; a water recovery unit (e.g., the water recovery unit 30 of the above embodiment) disposed on the exhaust fuel gas line, the water recovery unit being capable of recovering water contained in the exhaust fuel gas; a bypass line (e.g., the bypass line 50 of the above embodiment) which brings an upstream side and a downstream side of the exhaust fuel gas line with respect to the water recovery unit into communication; at least one flow control valve (e.g., the first flow control valve V1a, the second flow control valve V1b of the above embodiment) disposed on at least one of the exhaust fuel gas line or the bypass line; and a control unit (e.g., the control unit 380 of the above embodiment) capable of controlling an opening degree of the at least one flow control valve.

According to the above aspect (1), in a fuel cell power generation system including the first fuel cell and the second fuel cell capable of generating power using exhaust fuel gas from the first fuel cell, a water recovery unit for recovering water contained in the exhaust gas is disposed on the exhaust fuel gas line. The upstream side and the downstream side of the exhaust fuel gas line with respect to the water recovery unit are in communication via the bypass line, and it is possible to adjust the flow rate of exhaust fuel gas that passes through the water recovery unit by controlling the opening degree of the flow control valve disposed on at least one of the exhaust fuel gas line or the bypass line. Accordingly, by adjusting the water amount recovered from the exhaust fuel gas by the water recovery unit, it is possible to appropriately ensure the necessary water amount for the second fuel cell of the subsequent stage to the first fuel cell without relying on additional supply of water from outside while recovering extra water contained in the exhaust fuel gas, and recover heat with the regeneration heat exchanger, which makes it possible to achieve a high system efficiency.

(2) In another aspect, in the above aspect (1), the at least one flow control valve includes: a first flow control valve (e.g., the first flow control valve V1a) disposed on the exhaust fuel gas line; and a second flow control valve (e.g., the second flow control valve V1b) disposed on the bypass line, and the control unit is configured to control an opening degree ratio of the first flow control valve and the second-flow control valve.

According to the above aspect (2), by controlling the opening degree ratio of the first flow control valve and the second flow control valve, it is possible to change the flow rate of exhaust fuel gas that passes through the water recovery unit. Accordingly, it is possible to appropriately ensure the necessary water amount for the second fuel cell of the subsequent stage to the first fuel cell while recovering extra water contained in the exhaust fuel gas by adjusting the water recovery amount by the water recovery unit.

(3) In another aspect, in the above aspect (1) or (2), the control unit is configured to control the opening degree of the at least one flow control valve such that a water contained amount in the exhaust fuel gas supplied to the second fuel cell becomes equal to a water necessary amount of the second fuel cell.

According to the above aspect (3), by changing the flow rate of exhaust fuel gas that passes through the water recovery unit by controlling the opening degree of the flow control valve to adjust the water recovery amount by the water recovery unit, the water amount contained in exhaust fuel gas becomes the water amount necessary for the second fuel cell. Accordingly, it is possible to ensure the necessary water amount for the second fuel cell without additionally supplying water from outside while recovering extra water contained in exhaust fuel gas.

(4) In another aspect, in any one of the above aspects (1) to (3), the water recovery unit includes: a water condenser (e.g., the water condenser 33 of the above embodiment) for condensing and removing extra water contained in the exhaust fuel gas by cooling the exhaust fuel gas; and a regeneration heat exchanger (e.g., the above regeneration heat exchanger 32 of the above embodiment) configured to reheat the exhaust fuel gas after condensation and removal of the water.

According to the above aspect (4), the exhaust fuel gas after condensation and removal of water by the water condenser 33 is reheated by the regeneration heat exchanger, and thereby it is possible to increase the temperature of exhaust fuel gas supplied to the second fuel cell and improve the efficiency.

(5) In another aspect, in any one of the above aspects (1) to (4), the fuel cell power generation system includes a carbon dioxide recovery unit for recovering carbon dioxide from the exhaust fuel gas.

According to the above aspect (5), by recovering carbon dioxide contained in the exhaust fuel gas, it is possible to reduce the exhaust amount of carbon dioxide to the outside that becomes a greenhouse effect gas, and utilize the recovered carbon dioxide as a resource as needed.

(6) In another aspect, in any one of the above aspects (1) to (5), the control unit includes: a first electric current setting value calculation part (e.g., the first electric current setting value calculation part 382 of the above embodiment) configured to calculate a first electric current setting value of the first fuel cell on the basis of an output command value for the fuel cell power generation system; a fuel gas flow rate calculation part (e.g., the fuel gas flow rate calculation part 384 of the above embodiment) configured to calculate a flow rate of the fuel gas for the first fuel cell on the basis of the first electric current setting value; a component calculation unit (e.g., the component calculation unit 388 of the above embodiment) configured to calculate a contained amount of each component contained in the exhaust fuel gas on the basis of a flow rate of the fuel gas; and a water recovery amount calculation part (e.g., the water recovery amount calculation part 392 of the above embodiment) configured to calculate a water recovery amount by the water recovery unit on the basis of a calculation result of the component calculation unit. The control unit is configured to control the opening degree of the at least one flow control valve such that the water recovery amount by the water recovery unit becomes equal to a calculation result of the water recovery amount calculation part.

According to the above aspect (6), by calculating the electric current setting value of the first fuel cell, the flow rate of the fuel gas, and the contained amount of each component contained in the exhaust fuel gas in order on the basis of the output command value to the fuel cell power generation system, the water recovery amount by the water recovery unit is calculated. Furthermore, the control unit controls such that the water recovery amount by the water recovery unit becomes the calculation result by adjusting the opening degree of the flow control valve to change the flow rate of the fuel gas that passes through the water recovery unit.

(7) According to an aspect, a method of controlling a fuel cell power generation system which includes: a first fuel cell (e.g., the first fuel cell module 201A of the above embodiment) capable of generating electric power using a fuel gas (e.g., the fuel gas Gf of the above embodiment); a second fuel cell (e.g., the second fuel cell module 201B of the above embodiment) connected to a downstream side of the first fuel cell via an exhaust fuel gas line (e.g., the first exhaust fuel gas line 22A of the above embodiment), the second fuel cell being capable of generating electric power using an exhaust fuel gas (the first exhaust fuel gas Gefl of the above embodiment) from the first fuel cell; a water recovery unit (e.g., the water recovery unit 30 of the above embodiment) disposed on the exhaust fuel gas line, the water recovery unit being capable of recovering water contained in the exhaust fuel gas; a bypass line (e.g., the bypass line 50 of the above embodiment) which brings an upstream side and a downstream side of the exhaust fuel gas line with respect to the water recovery unit into communication; at least one flow control valve (e.g., the first flow control valve Vla and the second flow control valve Vlb of the above embodiment) disposed on at least one of the exhaust fuel gas line or the bypass line, includes controlling an opening degree of the at least one flow control valve such that a water contained amount in the exhaust fuel gas becomes equal to a water necessary amount of the second fuel cell.

According to the above aspect (7), in a fuel cell power generation system including the first fuel cell and the second fuel cell capable of generating electric power using exhaust fuel gas from the fuel cell, a water recovery unit for recovering water contained in the exhaust gas is disposed on the exhaust fuel gas line. The upstream side and the downstream side of the exhaust fuel gas line with respect to the water recovery unit are in communication via the bypass line, and it is possible to adjust the flow rate of exhaust fuel gas that passes through the water recovery unit by controlling the opening degree of the flow control valve disposed on at least one of the exhaust fuel gas line or the bypass line. Accordingly, by adjusting the water amount recovered from the exhaust fuel gas by the water recovery unit, it is possible to appropriately ensure the necessary water amount for the second fuel cell of the subsequent stage to the first fuel cell without relying on additional supply of water from outside while recovering extra water contained in exhaust fuel gas with the water recovery unit, which makes it possible to achieve a high system efficiency.

Reference Signs List
1 Fuel cell power generation system
10 Fuel cell part
20 Fuel gas supply line
22A First exhaust fuel gas line
22B Second exhaust fuel gas line
30 Water recovery unit
32 Exhaust fuel gas regeneration heat exchanger
33 Water condenser
34 Recovery water line
35 Cooling water line
40 Carbon dioxide recovery unit
50 Bypass line
101 Cell stack
103 Substrate tube
105 Single fuel cell
107 Interconnector
109 Fuel-side electrode
111 Electrolyte
113 Oxygen-side electrode
115 Lead film
201 Fuel cell module
201A First fuel cell module
201B Second fuel cell module
203 Fuel cell cartridge
205 Pressure vessel
207 Fuel gas supply pipe
207a Fuel gas supply branch pipe
209 Fuel gas exhaust pipe
209a Fuel gas exhaust branch pipe
215 Power generation chamber
217 Fuel gas supply header
219 Fuel gas exhaust header
221 Oxidant gas supply header
223 Oxidant gas exhaust header
225a Upper tube plate
225b Lower tube plate
227a Upper heat insulating body
227b Lower heat insulating body
229a Upper casing
229b Lower casing
231a Fuel gas supply hole
231b Fuel gas exhaust hole
233a Oxidizing gas supply hole
233b Oxidizing gas exhaust hole
235a Oxidizing gas supply gap
235b Oxidizing gas exhaust gap
237a, 237b Seal member
380 Control unit
382 First electric current setting value calculation part
384 Fuel gas flow rate calculation part
386 Exhaust fuel gas flow rate calculation part
388 Component calculation unit
390 Second electric current setting value calculation part
392 Water recovery amount calculation part
Gf Fuel gas
Gef1 First exhaust fuel gas
Gef2 Second exhaust fuel gas
V1a First flow control valve
V1b Second flow control valve
Vf Fuel gas supply amount adjustment valve

1. A fuel cell power generation system, comprising:
a first fuel cell capable of generating electric power using a fuel gas;
a second fuel cell connected to a downstream side of the first fuel cell via an exhaust fuel gas line, the second fuel cell being capable of generating electric power using an exhaust fuel gas from the first fuel cell;
a water recovery unit disposed on the exhaust fuel gas line, the water recovery unit being capable of recovering water contained in the exhaust fuel gas;
a bypass line which brings an upstream side and a downstream side of the exhaust fuel gas line with respect to the water recovery unit into communication;
at least one flow control valve disposed on at least one of the exhaust fuel gas line or the bypass line; and
a control unit capable of controlling an opening degree of the at least one flow control valve.

2. The fuel cell power generation system according to claim 1,
wherein the at least one flow control valve includes:
a first flow control valve disposed on the exhaust fuel gas line; and
a second flow control valve disposed on the bypass line, and
wherein the control unit is configured to control an opening degree ratio of the first flow control valve and the second flow control valve.

3. The fuel cell power generation system according to claim 1,
wherein the control unit is configured to control the opening degree of the at least one flow control valve such that a water contained amount in the exhaust fuel gas supplied to the second fuel cell becomes equal to a water necessary amount of the second fuel cell.

4. The fuel cell power generation system according to claim 1,
wherein the water recovery unit includes:
a water condenser for condensing and removing extra water contained in the exhaust fuel gas by cooling the exhaust fuel gas; and
a regeneration heat exchanger configured to reheat the exhaust fuel gas after condensation and removal of the water.

5. The fuel cell power generation system according to claim 1, comprising:
a carbon dioxide recovery unit for recovering carbon dioxide from the exhaust fuel gas.

6. The fuel cell power generation system according to claim 1,
wherein the control unit includes:
a first electric current setting value calculation part configured to calculate a first electric current setting value of the first fuel cell on the basis of an output command value for the fuel cell power generation system;
a fuel gas flow rate calculation part configured to calculate a flow rate of the fuel gas for the first fuel cell on the basis of the first electric current setting value;
a component calculation unit configured to calculate a contained amount of each component contained in the exhaust fuel gas on the basis of a flow rate of the fuel gas; and
a water recovery amount calculation part configured to calculate a water recovery amount by the water recovery unit on the basis of a calculation result of the component calculation unit, and
wherein the control unit is configured to control the opening degree of the at least one flow control valve such that the water recovery amount by the water recovery unit becomes equal to a calculation result of the water recovery amount calculation part.

7. A method of controlling a fuel cell power generation system comprising:
a first fuel cell capable of generating electric power using a fuel gas;
a second fuel cell connected to a downstream side of the first fuel cell via an exhaust fuel gas line, the second fuel cell being capable of generating electric power using an exhaust fuel gas from the first fuel cell;
a water recovery unit disposed on the exhaust fuel gas line, the water recovery unit being capable of recovering water contained in the exhaust fuel gas;
a bypass line which brings an upstream side and a downstream side of the exhaust fuel gas line with respect to the water recovery unit into communication; and
at least one flow control valve disposed on at least one of the exhaust fuel gas line or the bypass line, the method comprising:
controlling an opening degree of the at least one flow control valve such that a water contained amount in the exhaust fuel gas becomes equal to a water necessary amount of the second fuel cell.
